(19) United States
(12) Patent Application Publication
(10) Pub. No.: US 2021/0212351 A1
(43) Pub. Date: Jul. 15, 2021

(54) SWEET RAPESEED PROTEIN ISOLATE

(71) Applicant: DSM IP ASSETS B.V., Heerlen (NL)

(72) Inventors: Marco Alexander VAN DEN BERG, Echt (NL); Jing SHI, Echt (NL)

(21) Appl. No.: 16/769,184

(22) PCT Filed: Dec. 4, 2018
(86) PCT No.: PCT/EP2018/083425

§ 371 Date: Jun. 2, 2020

(30) Foreign Application Priority Data
Dec. 5, 2017 (EP) 17205438.9
Jan. 5, 2018 (EP) 18150466.3

(51) Int. Cl. A23L 27/30; A23J 1/14; A23L 33/185; A23C 11/06

(52) U.S. Cl. CPC A23L 27/30; A23J 1/14; A23V 2002/00; A23C 11/06; A23L 33/185

(57) ABSTRACT

The present invention is directed to a sweet rapeseed protein isolate, compositions, food products and beverages comprising rapeseed protein isolate and the use of rapeseed protein isolate protein having a sweetening effect.

### FIELD OF THE INVENTION

The present invention is directed to a sweet rapeseed protein isolate, compositions, food products and beverages comprising rapeseed protein isolate and the use of rapeseed protein isolate protein having a sweetening effect.

### BACKGROUND OF THE INVENTION

Sweeteners are well known as ingredients used most commonly in the food, beverage, or confectionary industries. The sweetener can either be incorporated into a final food product during production or for stand-alone use, when appropriately diluted, as a tabletop sweetener or an at-home replacement for sugars in baking. Sweeteners include natural sweeteners such as sucrose, high fructose corn syrup, molasses, maple syrup, and honey and artificial sweeteners such as aspartame, saccharine, and sucralose.

Sweetness is determined from sensory profiles. For example, some substances can have a faster sweetness build (i.e., a shorter time to maximum sweetness intensity), some have an immediate sweetness onset (i.e., immediate perception of sweetness), some have an artificial sweetness, some may have a more bitter or acidic taste. Artificial sweetness refers to the intensity of flavor that is associated with known artificial sweeteners. Bitter taste is assessed as the taste of caffeine and can be scored as having no perception of bitterness to very intense bitterness. Acidic taste is assessed as the taste of citric acid and can be scored as having no perception of acidity to very intense acidity. Such characteristics can be perceived by consumers and assessed/quantified by using trained sensory panels.

In view of health concerns related to the consumption of sugar, there have been several research efforts for sugar substitutes, such as the use of so-called high intensity sweeteners. However, a problem with high intensity sweeteners is that often they do not provide the same sensorial properties of sugar and may introduce off flavors.

High intensity sweeteners provide sweetness levels many times exceeding that of sucrose. One class of high intensity sweeteners are sweet proteins, examples of which are thaumatin, monellin, mabinlin, pentadin, brazzein and curculin. The sweetness potential of these proteins is very high with sweetness equivalent factors of 100 to 3000 (Faus et al. (2005) Sweet-tasting Proteins, Biopolymers Online 8, 203-210, in: Polyamides and Complex Proteinaceous Materials, Wiley-VCH Verlag GmbH & Co). This means that at the same weight percentage in solution these sweet proteins supply a 100 to 3000-fold sweetness of an equal weight percentage of sucrose in solution. Although these proteins offer great sweetness potential, they are hardly applied in food due to their sensory limitations. For example, the temporal taste profile of thaumatin is characterized by a delay in perceived sweetness, a lengthy sweet phase, followed by a lingering and liquorice aftertaste, making it virtually incompatible with mainstream food and drink applications (Lindley M. G. (2012) Natural High-Potency Sweeteners, in: Sweeteners and Sugar Alternatives in Food Technology, Second Edition; eds. O'Donnell, K. and Kearsley, M. W., Wiley-Blackwell, Oxford, UK, 184-207). Besides thaumatin, currently none of the other sweet proteins is commercially available. Moreover, several of the natural sources of these sweet proteins are only growing in distant regions (i.e. Mabinlin from the seeds of the mabinlang (Capparis masaikai), a Chinese plant growing in Yunnan province) or are available in only limited amounts.

Other high intensity sweeteners like aspartame or acesulfame are synthetic and are not appreciated by consumers looking for naturalness and organic labeling of food products. Still other high intensity sweeteners—which can be labeled as natural-like steviol glycosides and mogrosides, do require the presence of polymers or bulking agents as inulin or sugar alcohols when applied in food products like cereals and bars to repair the textural issues associated with reduced sucrose levels in the food product.

Therefore, there is a need for sweeteners which can be labeled as natural, that have a sucrose-like sensory profile, and that do not require the addition of bulking agents.

The use of vegetable-based proteins in food products is known, for example WO 2008/094434 discloses the use of wheat protein isolates as an alternative to the use of egg yolk protein in compositions. However, the use of wheat protein isolates may not be desirable for those with gluten allergies and there may also be intolerances to soy-based proteins and egg white based proteins. Alternatively, soy protein is widely used. However, in view of some intolerance to soy products there is a need to find still other sources of vegetable proteins. Suitable alternatives include pea protein and rapeseed protein. Rapeseed seeds are rich in oil and contain considerable amounts of protein that accounts for 17 to 25% of seed dry weight. Processing rapeseed for oil for human consumption produces rapeseed meal (also referred to as cake) as a by-product which contains about 30 to 40% protein. The rapeseed used for this purpose is usually of the varieties Brassica napus and Brassica juncea. These varieties contain only low levels of erucic acid and glucosinolate and are also known as Canola. Canola is a contraction of Canada and ola, for “oil low acid”, but is now a generic term defined as rapeseed oil comprising <2% erucic acid and <30 mmol/g glucosinolate. The resultant rapeseed meal is currently used as a high-protein animal feed.

Protein is available as hydrolysates, native protein, concentrates and isolates. Hydrolysates are proteins that have been partially broken down by exposing the protein to heat, acid or enzymes that break apart the bonds linking amino acids. This makes hydrolysates taste more bitter, but also allows them to be absorbed more rapidly during digestion than native (non-hydrolyzed) protein. Isolates are purer than concentrates, meaning other non-protein components have been partially removed to “isolate” the protein. Many concentrates are around 80% protein, which means that on a dry basis, 80% of the total weight is protein. Isolates are typically around 90% protein (dry basis). This is calculated using the Kjeldahl method. The predominant storage proteins found in rapeseed are cruciferins and napins.

Cruciferins are globulins and are the major storage protein in rapeseed. It is composed of 6 subunits and has a total molecular weight of approximately 300 kDa. Napins are albumins and are a low molecular weight storage protein with a molecular weight of approximately 14 kDa.

The ability to utilize a protein which is vegetable in origin in food products enables truly vegetarian food products to be provided in instances where egg white and/or animal-derived protein have been used in the absence of available substitutes.

However, it is also known that protein extracts from legumes, such as soya, pea, or lupin, have a fragrance typical of legumes which is described by test subjects in sensory taste tests as grassy, bean-like, pea-like or green and some rapeseed and sunflower extracts often produce bitter and astringent taste impressions. US 2011/027433 describes the use of an inorganic adsorbed material that, added to the vegetable protein extract, removes unwanted accompanying substances, especially fragrance, flavor, and/or color components. WO 2007/039253 describes hydrolyzed vegetable protein which is obtainable by the hydrolysis of a mixture comprising sunflower protein and at least one other vegetable protein (preferably maize protein) which has improved flavor and/or aroma properties. WO 2004/006693 describes a food product which comprises seed of an oil plant as protein supplement, the oil content of which seed has been reduced. The seed is heat-treated turnip rapeseed or rapeseed meal, where the digestibility of proteins and/or aroma is improved because of heat treatment. US 2004/005395 discloses a fractionated rapeseed protein isolate and its use as a flavor-enhancer in a food product where something sweet becomes sweeter and something salty becomes saltier.

In summary, in many protein enriched food products additional sugar still is required to mask the off-taste of the protein and there remains a further need to provide protein enriched compositions, such as beverages, that contain a reduced level of sugar but still have a good flavor balance and nutritional profile.

Traditionally, for materials having relatively high oil content (>35% on dry matter, rapeseed is approximately 40%) a combination of mechanical pressing and solvent extraction is used for an efficient extraction of the oil (Rosenthal et al., Enzyme and Microbial Technology 19 (1996) 402-420). After the oil is extracted, the pressed material is heat treated to remove the solvent, resulting in a meal with an oil and protein content of 1 to 5% and 40 to 50% of the dry matter, respectively. Although the meal has a relative high protein content, the quality of the proteins is reduced significantly resulting from the harsh conditions (i.e., elevated temperature, solvents) employed during the oil extraction. The awareness that these oil extraction conditions are detrimental for the quality of the proteins is one of the factors bolstering the improvement of the cold pressing technology. During cold pressing, no solvents (like e.g. hexane) are used and the oil is pressed out under mild conditions, resulting in better quality oil and an oilseed pressed meal of higher quality. This oilseed pressed meal has a relatively high oil content (typically >8%) and is an excellent source of proteins with preserved functionality. These proteins can be readily extracted from the meal by aqueous extraction (Rosenthal et al., Enzyme and Microbial Technology 19 (1996) 402-420, Rosenthal et al., Trans iChemE, Part C, 76 (1998) 224-230 and Lawhon et al., J. Food Sci. 46 (1981) 912-916). One of the biggest challenges of this type of processes is that during extraction proteins and oil are extracted concomitantly. This leads to an extract containing a significant amount of oil, present in most cases partly as a stable emulsion making its removal quite difficult. WO 2014/147068 discloses mild extraction of cold-pressed rapeseed meal to obtain protein-rich extracts that are practically fat-free.

We have found that in the process of the instant invention, based on cold-pressed rapeseed meal, a rapeseed protein isolate is obtained with a high level of napins and low content of antinutritional phenolics while simultaneously displaying an unprecedented high solubility. It has been found that the rapeseed protein isolate of the present invention is inherently sweet and can therefore be effectively used to reduce the amount of sucrose in food products and simultaneously enrich the protein level, and therefore increase the nutritional value of a food product.

### DESCRIPTION OF THE FIGURE

FIG. 1 depicts the color in solution obtained after incubation at 56° C. of rapeseed protein extracts, prepared with different concentrations of L-ascorbic acid and/or sodium metabisulfite in the extraction liquid at different time intervals. X-axis: incubation time in hours. Y-axis: 100-L value. Note that, following the measurements at t=3 h, experiments were temporarily stopped by storing the samples for a longer time (10 weeks) at −20° C. After this, measurements were continued by continuing incubation at 56° C. at the times indicated in the Figure, i.e. the time span wherein samples were frozen is omitted from the graph. Explanation of the symbols: ∘=control; ⋄=L-ascorbic acid (0.5 g/kg); □=sodium metabisulfite (0.1 g/kg); ●=L-ascorbic acid (0.25 g/kg) plus sodium metabisulfite (0.05 g/kg); ▪=L-ascorbic acid (0.25 g/kg) plus sodium metabisulfite (0.1 g/kg); ▴=L-ascorbic acid (0.5 g/kg) plus sodium metabisulfite (0.05 g/kg); ♦=L-ascorbic acid (0.5 g/kg) plus sodium metabisulfite (0.1 g/kg).

### DETAILED DESCRIPTION OF THE INVENTION

In a first aspect of the invention, there is provided a native rapeseed protein isolate comprising more than 60 wt. % napins and from 30 to 3,000 mg/kg of phenolics.

In the context of the invention, phenolics are compounds that possess a phenol moiety. Examples of phenolics that normally occur in rapeseed prior to exposure to the process of the second aspect of the invention are hydroxycinnamic acids, examples of which are m-coumaric acid, o-coumaric acid, p-coumaric acid, ferulic acid, and sinapic acid, but also compounds derived therefrom such as 4-vinylsyringol and the like. The term “phenolics” also encompasses compounds that are referred to in the art as polyphenolics. Tyrosine and peptides and proteins comprising tyrosine are excluded from the above definition of phenolics.

In an embodiment, the native rapeseed protein isolate of the invention has from 250 to 2,500 mg/kg of phenolics. In another embodiment, the native rapeseed protein isolate of the invention has from 500 to 2,000 mg/kg of phenolics. In another embodiment, the native rapeseed protein isolate of the invention has from 1,600 to 1,900 mg/kg of phenolics

In an embodiment, the native rapeseed protein isolate of the invention has, in a 2 wt. % solution in water, a sweetness equivalent to an aqueous sucrose solution of at least 10 g/L.

In one embodiment, the native rapeseed protein isolate of the invention comprises napins that are proteins with a molecular weight of from 10 to 15 kDa as determined by Blue Native PAGE. In an embodiment, the native rapeseed protein isolate is napin, a 1.7-2S albumin. The term napin includes several isoforms, known as Napin-1, Napin-2, Napin-3, Napin-1A, Napin-B and Nap1 with molecular mass ranging from 12.5 to 14.5 kDa. Mature napin comprises a small (short, ˜4 kDa) and a large (long, ˜9 kDa) polypeptide chain linked together by two inter-chain disulfide bonds, while the large chain possesses two intra-chain disulfide bonds (Shewry et al., Plant Cell. 7 (1995) 945-956).

In another embodiment, the native rapeseed protein isolate comprises 60 to 100 wt. % napins, preferably 70 to 97 wt. % napins, more preferably 80 to 95 wt. % napins, for example 80±10 wt. % napins or 85±10 wt. % napins.

In another embodiment, the native rapeseed protein isolate has, in a 2 wt. % solution in water, a sweetness equivalent to an aqueous sucrose solution of at least 20 g/L, preferably of from 25 to 125 g/L, more preferably of from 30 to 100 g/L.

Alternatively, the level of sweetness may be expressed as sweetness equivalent factor. In an embodiment, the native rapeseed protein isolate of the invention has a sweetness equivalent factor of at least 0.5. This means that when brought into a 2 wt. % solution in water, the sweetness is equivalent to an aqueous sucrose solution of at least 10 g/L. Preferably, the native rapeseed protein isolate has a sweetness equivalent of least 15 g/L of sucrose (meaning a sweetness equivalent factor of at least 0.75), more preferably at least 25 g/L of sucrose (meaning a sweetness equivalent factor of at least 1.25), or at least 30 g/L of sucrose (meaning a sweetness equivalent factor of at least 1.5), at least 35 g/L of sucrose (meaning a sweetness equivalent factor of at least 1.75), at least 40 g/L of sucrose (meaning a sweetness equivalent factor of at least 2.0), at least 45 g/L of sucrose (meaning a sweetness equivalent factor of at least 2.25), at least 50 g/L of sucrose (meaning a sweetness equivalent factor of at least 2.5), or even around 100 g/L of sucrose (meaning a sweetness equivalent factor of at least 5) such as from 70 to 130 g/L (meaning a sweetness equivalent factor ranging from 3.5 to 6.5) as such amounts compare to the sweetness of some of the high sugar beverages that are available on the market.

The sweetness equivalent factor of an aqueous solution containing a predetermined weight percentage of the native rapeseed protein isolate of the present invention (for example 1%, 2% or 3%) is determined by evaluating and comparing the sweetness by trained sensory panelists versus fixed reference solutions of sucrose and confirming the actual sucrose solution/concentration providing similar sweetness. The sweetness equivalent factor of an aqueous solution containing a predetermined weight percentage of the native rapeseed protein isolate of the present invention (for example 1%, 2% or 3%) can then be calculated by dividing the concentration (in g/L) of equally sweet solutions of sucrose by the native rapeseed protein isolate of the present invention. As a non-limiting example of such a calculation: if a 2% aqueous solution of the native rapeseed protein isolate of the present invention is equally sweet to a 3% sucrose solution, the sweetness equivalent factor is 30/20=1.5.

In another embodiment, the native rapeseed protein isolate of the invention has a solubility of at least 88%, preferably at least 90%, more preferably at least 94%, and most preferably at least 96%, at a pH in the range of from 3 to 10 at a temperature of 23±2° C. This is also known as the soluble solids index (SSI).

For use in human food consumption the native rapeseed protein isolate preferably comprises a low level of salt. This is established by measuring the conductivity. Preferably the conductivity of the native rapeseed protein isolate in a 2 wt. % aqueous solution is less than 9,000 μS/cm over a pH range of 2 to 12. More preferably the conductivity of the native rapeseed protein isolate in a 2 wt. % aqueous solution is less than 4,000 μS/cm over a pH range of 2.5 to 11.5. For comparison, the conductivity of an aqueous 5 g/L sodium chloride solution is around 9,400 μS/cm. In another embodiment, the native rapeseed protein isolate has a phytate level of less than 0.4 wt. %, preferably of less than 0.25 wt. % and more preferably of less than 0.15 wt. %.

In still another embodiment, the native rapeseed protein isolate has a protein content of at least 90 wt. % (calculated as Kjeldahl N×6.25) on a dry weight basis, more preferably at least 94 wt. %, most preferably at least 96 wt. % and especially at least 98 wt. %.

Preferably the native rapeseed protein isolate is substantially unhydrolyzed. By substantially unhydrolyzed is meant that the protein is not deliberately hydrolyzed.

In another embodiment of the invention there is provided a composition comprising at least 0.1 wt %, more preferably at least 0.5 wt % and most preferably at least 1 wt % of a rapeseed isolate according to the invention, said composition having a statistically significant increase in a sweetness score relative to the composition comprising 0 wt % of a rapeseed isolate of the invention.

In a second aspect of the invention, there is provided a process for obtaining a native rapeseed protein isolate according to the first aspect of the invention comprising the steps of:
i) mixing cold-pressed rapeseed oil meal with an aqueous liquid at a temperature of from 45 to 65° C.;
ii) separation of the aqueous liquid from the mixture obtained in step i);
iii) decreaming of the aqueous liquid obtained in step ii);
iv) adjusting the pH of the decreamed aqueous liquid obtained in step iii) to neutral by adding acid or base, and mixing with a precipitant to obtain a precipitate wherein said precipitant comprises a salt of magnesium, zinc, iron, or calcium;
v) removing the precipitate obtained in step iv) to obtain an aqueous liquid;
vi) concentrating and washing the aqueous liquid obtained in step v);
vii) subjecting the concentrated and washed aqueous liquid obtained in step vi) to filtration over a membrane with a cut off >50 kDa;
viii) subjecting the permeate obtained in step vii) to filtration over a membrane with a cut off between 5 and 50 kDa;
ix) isolating native rapeseed protein isolate from the concentrated and washed aqueous retentate obtained in step vi) by means of drying.
whereby ascorbic acid or a derivative thereof and a sulfite is added before, during or after any of steps i) or ii) or iii) or iv) or v) or vi).

As outlined above, the rapeseed protein isolate is produced from cold pressed rapeseed press meal, the by-product of rapeseed oil production.

The process starts with an extraction step i), in which rapeseed meal is combined with an aqueous salt solution, for example 0 to 5% sodium chloride, at a temperature between 4 to 75° C., more preferably 20 to 75° C. and most preferably 45 to 65° C. Preferably, in step i) said mixing is carried out such that the ratio between said cold-pressed rapeseed oil meal and said aqueous liquid is from 1:2 to 1:30 (w/w). Preferably the meal to water ratio is in the range of from 1:5 to 1:40, more preferably 1:5 to 1:20.

After a period in the range of from 5 min to 2 hours the protein rich solution is separated from the insoluble material in the separation step ii). The protein rich solution is hereafter referred to as the extract.

The pH of the extract is preferably adjusted to neutral and the extract is further processed to clarify the material and remove non-protein substances. In the decreaming step iii), the residual fat and formed precipitates are removed via a solid/liquid separation step (e.g. filtration or centrifugation). Preferably, the decreaming in step iii) is carried out by means of centrifugation.

The extract is then separated, concentrated, and washed in an ultrafiltration/diafiltration (UF/DF) step vi). The UF/DF step has the purpose of enriching the relative percentage of napins present in the rapeseed protein isolate, concentrating the protein and removing anti-nutritional factors (e.g. phenolics, polyphenols, residual phytate, glucosinolates). The concentrating and washing in step vi) is preferably carried out by means of ultrafiltration and diafiltration.

In step vii) the obtained solution is subjected to filtration over a membrane with a cut off >50 kDa. The retentate so obtained is enriched in high MW proteins such as cruciferins (in the Examples referred to as fraction I) and the permeate is enriched in low MW proteins such as napins.

In step viii), the permeate obtained in step vii) is subjected to filtration over a membrane with a cut off between 5 and 50 kDa. The retentate so obtained is enriched in low MW proteins such as napins. The choice of membranes from will be apparent to do those skilled in the art. Optionally, in both steps vii) and viii) retentates may be washed with water or aqueous solutions prior to further processing.

Finally, in step ix), the washed concentrate may be dried in a suitable dryer, such as a spray drier (single or multistage) with an inlet temperature in the range of from 150 to 200° C. and an outlet temperature in the range of from 50 to 100° C. resulting in the rapeseed protein isolate.

Ascorbic acid or a derivative thereof and a sulfite are present during the process or during parts of the process. Accordingly, ascorbic acid or a derivative thereof and a sulfite are added before, during or after any of steps i) or ii) or iii) or iv) or v) or vi).

In an embodiment, the ascorbic acid or a derivative thereof is L-ascorbic acid or calcium L-ascorbate or potassium L-ascorbate or sodium L-ascorbate. In another embodiment, the sulfite is an ammonium or metal salt of sulfite, bisulfite or metabisulfite. Non-limiting examples are sodium metabisulfite or potassium metabisulfite.

The amount of ascorbic acid or a derivative thereof can vary amongst wide ranges. Suitable examples are wherein the amount of ascorbic acid is from 0.05 to 5 g/kg, or from 0.25 to 1 g/kg relative to the mixture of cold-pressed rapeseed oil meal and aqueous liquid. The amount of sulfite is from 0.01 to 0.5 g/kg, or from 0.05 to 0.1 g/kg relative to the mixture of cold-pressed rapeseed oil meal and aqueous liquid. Alternatively, the amounts of ascorbic acid and sulfite are expressed in percentages relative to the total weight of the composition. Hence, for ascorbic acid this may range from 0.005 to 0.5% (w/w), or from 0.025 to 0.1% (w/w) and for sulfite this may range from 0.001 to 0.05% (w/w), or from 0.005 to 0.01% (w/w).

Interestingly, the combination of ascorbic acid or derivatives thereof with a sulfite resulted in an unprecedented effect. For example, the application of a metabisulfite results in an initial removal of color which appeared however not persistent over time and in some cases, after prolonged incubation, even results in a darker color. On the other hand, the application of ascorbic acid results in a smaller initial removal of color, but this is more stable over time and eventually results in significantly lower color values. When, according to the invention, ascorbic acid and metabisulfite are combined, an effect is observed whereby the resultant color of the process stream in question is below that of the stream tested with the individual components. Notably, L color values obtained according to the invention, as further defined in the second aspect of the invention, are significantly higher than those reported for prior art rapeseed protein isolates.

It was found that levels of phenolics in the final rapeseed protein isolate decreased significantly compared to those present in the starting material. Since phenolics are antinutritional components this represents a valuable advantage associated with the present invention. Levels of phenolics in the starting material, i.e. in cold-pressed rapeseed meal range from 10,000 to 20,000 mg/kg, for example from 17,000 to 17,600 mg/kg. Processing such cold-pressed rapeseed meal without ascorbic acid or derivatives thereof with a sulfite results in reduction of the level of phenolics to 3,500 to 10,000 mg/kg, for example to 3,500 to 7,400 mg/kg. However, following the process of the invention using ascorbic acid or derivatives thereof and a sulfite results in still lower levels of phenolics of below 3,500 mg/kg as outlined above in the first aspect.

In one embodiment, method steps i)-vi) are carried out in 1-8 h, preferably in 3-5 h during which time span the maximal difference with the untreated control is observed. In another embodiment method steps i)-vi) are carried out in under 4 h, preferably from 30 min-3.5 h, conditions under which the color of the extract (expressed in 100-L), and hence that of the final product, is well below that of untreated extract but also below that of extract treated with ascorbic acid or sulfite alone.

An advantage of the method of the first aspect is that no significant decrease in the proteins of interest, notably cruciferins and napins, is observed. This is particularly surprising for the napins that are known to be prone to degradation. Under the conditions mentioned above napin concentrations remain above 95% of the initial napin concentration of the control.

An additional advantage of the method of the first aspect is that untreated clear solutions of rapeseed protein isolate obtained during the process tend to develop a dark colored precipitate over time where this does not happen with samples obtained during the method of the invention.

The method of the instant invention is characterized in that it is well-suited for large-scale application. Hence, in one embodiment the method is carried out at a scale of at least 500 kg, preferably of from 500 to 10,000 kg or from 1,000 to 5,000 kg.

Preferably the rapeseed protein isolate is obtained in a process where the levels of napin are higher than the levels of cruciferin (i.e. the native rapeseed protein isolate comprises 60 to 100 wt. % napins).

It has been found that the soluble native rapeseed protein isolate comprising 60 to 100 wt. % napins, obtained from cold pressed oilseed meal and extracted under mild conditions as described in the second aspect of the invention, has a surprisingly sweet flavor. Preferably the native rapeseed protein isolate comprises 60 to 100 wt. % napins. The native rapeseed protein isolate as disclosed herein has a sweetness that is higher, under certain conditions even 2 to 3 times, than that of other protein isolates such as from pea, rice, soy, and whey.

In a third aspect of the invention, there is provided the use of native rapeseed protein isolate to increase the sweetness of a food product.

In an embodiment, the native rapeseed protein isolate is used to increase the sweetness and the protein level of a food product.

In another embodiment, the native rapeseed protein isolate used to increase sweetness, or sweetness and protein level of a food product, is administered as part of the native rapeseed protein isolate according to the first aspect of the invention.

In yet another embodiment, the invention provides the use of native rapeseed protein isolate to reduce the amount of (added) sugar and/or (added) sucrose in a food product.

In an embodiment, the native rapeseed protein isolate is napin.

Consequently, the native rapeseed protein isolate of the invention can be used in food products and dietary supplements, such as for example, ice cream, milk powder, beverages, chocolate, fruit juices, yogurts, dairy products, baked goods, cereals, health bars, confectionary products, and emulsions such as mayonnaise and salad dressings. The food products of may further comprise other ingredients, such as, for example, food starches, sweeteners, spices, seasonings (including salt), food pieces, stabilizers, antioxidants, sterols, soluble fiber, gums, flavorings, preservatives, colorants, and various combinations of any thereof.

In one embodiment, the present food products and dietary supplements, sweetened by the native rapeseed protein isolate of the invention, have a sweetness that equals the sweetness of similar sweetened food products and dietary supplements having added sucrose in an amount of more than 0.5 wt. %, more than 1 wt. %, more than 2 wt. %, more than 3 wt. %, more than 4 wt. % or more than 5 wt. %, for example from 0.5 to 15 wt. %, or 5 to 10 wt. %, or 10 to 15 wt. %.

In one embodiment, one or more other sweeteners may be included in the present food products and dietary supplements, such as sucrose, fructose, maltose, lactose, galactose, a steviol glycoside like rebaudioside M, rebaudioside D, rebaudioside A or a Stevia extract, a mogroside or Luo Han Guo extract, thaumatin, brazzein, mabinlin, monellin, monatin, pentadin, miraculin, curculin, neoculin, neohesperidin dihydrochalcone (NHDC), phyllodulcin, glycyrrhizic acid and its salts, sucralose, acesulfame K, alitame, aspartame, cyclamate, erythritol, maltitol, mannitol, sorbitol, lactitol, xylitol, inositol, threitol, arabitol, isomalt, propylene glycol, glycerol, galactitol, hydrogenated isomaltulose, reduced isomalto-oligosaccharides, reduced xylo-oligosaccharides, reduced gentio-oligosaccharides, reduced maltose syrup, reduced glucose syrup, neotame, saccharin, tagatose, kojibiose, allose, allulose, psicose, palatinose, mannose, sorbose, inulin or fructooligosaccharide.

In another embodiment, in the present food products and dietary supplements, sweetened by the native rapeseed protein isolate of the invention, the amount of added sucrose can be reduced while maintaining food products and dietary supplements having the desired sensory properties with from 0.5 wt. % to at least 10 wt. %, for example from 1 wt. % to 5 wt. %. In yet another embodiment, sweetening by adding the native rapeseed protein isolate of the invention leads to a reduction of the total amount of added sugar, while maintaining food products and dietary supplements having the desired sensory properties, with at least 25%, preferably at least 40%, more preferably at least 50%, more preferably at least 75%, and still more preferably 100%. The present food products and dietary supplements, sweetened by the native rapeseed protein isolate of the invention, comprise a total amount of added sucrose less than 10 wt. %, more preferably less than 8 wt. %, more preferably less than 5 wt. % (wt), even more preferably less than 2 wt. % (wt), and most preferably between 0 and 1 wt. %.

In one embodiment, for certain food applications it is desirable to increase the protein content while maintaining the flavor. For example, in U.S. Pat. No. 4,493,853, a chocolate product is described having an increased protein content by the addition of processed cheese. While this approach has several disadvantages, like the relatively large amounts of expensive processed cheese used, the need to increase protein content in chocolate clearly exists. Similarly, plant-based protein bars are nowadays gaining popularity, and several are available having plant-based protein contents of around 20%. Such bars are made with ingredients such as nuts, nut butters, pumpkin seeds, crisped peas, and rice and the like and are optionally dipped and drizzled with chocolate. These bars are intended as on-the-go wholesome protein snack to provide long-lasting energy and satiety.

The native rapeseed protein isolate of the present invention can function as protein additive in food products such as bars, chocolate, and the like.

In one embodiment, the present food products, and dietary supplements, sweetened by the native rapeseed protein isolate of the invention, may contain 0.01 wt. % to 10 wt. % of the native rapeseed protein isolate of the invention, preferably 0.1 wt. % to 5 wt. %, more preferably 0.5 wt. % to 4 wt. % such as 1 wt. %, 2 wt. % or 3 wt. %.

In one embodiment, the present food products, and dietary supplements, sweetened by the native rapeseed protein isolate of the invention, may contain 0.01 wt. % to 10 wt. % of napins, preferably 0.1 wt. % to 5 wt. %, more preferably 0.5 wt. % to 4 wt. % such as 1 wt. %, 2 wt. % or 3 wt. %.

In a fourth aspect of the invention, there is provided a food product comprising the rapeseed protein isolate according to the invention. Suitable examples are bars and/or chocolate, beverages, or milk-based powders such as applied in coffee machines.

Non-limiting Examples of the invention are described below.

### EXAMPLES

### Test Methods

Protein Content

Protein content was determined by the Kjeldahl method, AOAC Official Method 991.20 Nitrogen (Total) in Milk, using a conversion factor of 6.25, to determine the amount of protein (wt %).

Color Measurement Using UV-Spectrophotometer

Color values were determined using an UV-spectrophotometer (TECAN Infinite M1000 Pro plate reader) with 96-wells plates. The sample volume per well was 275 μl. Samples were clarified by filtration (0.45 μm) before absorbance measurements.

Measured absorbance at 400-700 nm (10 nm interval, corrected for blank (MilliQ water)) was converted to L values using the formulas as described in DIN 5033 Part 3 and DIN 6174. For the calculation of L, illuminant D65 was used and the “CIE 1964 supplementary standard colorimetric observer” standard spectral functions with an observer angle of 10°. For comparison of 100-L between different samples, extrapolated 100-L values were used since L (or 100-L) does not have a linear relationship with sample concentration.

Samples were taken from in-process streams at equal pH, without further dilution.

Color Measurement Using Hunterlab Spectrophotometer

Color spectrophotometer: Hunterlab UV VIS, D-SV032
Accessory: Cuvette Holder, placed between sphere and lens
Mode: RTRAN-Regular Transmission, UVF nominal
Port plate: Standard, 25.400 mm
Standardization: White color reference standard
Blank: Cuvette filled with buffer solution
Sample cuvette: Brandt 7590.05, Plastic, 10×10 mm

With the Hunterlab spectrophotometer, color is defined as a fixed point in three-dimensional space. The parameters measured are the L, a, and b values.
L value: the amount of white saturation in a sample: a value of 100 is white, a value of 0 is black
a value: the color saturation green to red: a positive value is the red saturation, a negative value is the green saturation
b value: the color saturation yellow to blue: a positive value is the yellow saturation, a negative value is the blue saturation
YI E313: Yellowness Index (ASTM E313); a mathematical calculation that is used to express the yellowness of a sample: the higher the value, the more yellow the sample is

For defining whiteness obtained after decolorization, the measured L values are preferably used.

Phenolics Content

Analysis of phenolics in rapeseed protein isolate samples was based on the analysis of potato phenolics described in Narvaez-Cuenca, C-E., Journal of Agricultural and Food Chemistry (2011) 59 (10247-10255).
Apparatus: Acquity UPLC (Waters) consisting of pump, injector, sample manager and column oven
   Acquity PDA detector (Waters)
   Centrifuge 5417C (Eppendorf)
   Balance (Mettler PM480 Deltarange)
Conditions: Injection volume: 2 μL, Full loop
   Detection: UV-detection at 320 nm
   Flow: 0.400 mL/min.
   Column: Waters Acquity UPLC BEH C18, 1.7 μm, 2.1×150 mm
   Column temp.: 30° C.
   Pressure limits: 0-15.000 psi
   Mobile phase A: 0.1% formic acid in water
   Mobile phase B: 0.1% formic acid in acetonitrile
   Weak wash: 5% acetonitrile in Milli-Q water
   Strong wash: 95% acetonitrile in Milli-Q water

| | Time (min.): | 0.0 | 5.0 | 22.0 | 23.0 | 27.0 | 28.0 | 35.0 |
|---|---|---|---|---|---|---|---|---|
| Gradi- | % A: | 99.0 | 99.0 | 40.0 | 10.0 | 10.0 | 99.0 | 99.0 |
| ent: | % B: | 1.0 | 1.0 | 60.0 | 90.0 | 90.0 | 1.0 | 1.0 |

Pretreatment standard: approximately 10 mg sinapic acid standard (Aldrich), was weighed accurately to 0.01 mg and dissolved in 50.0 mL of an aqueous solution of methanol (50%) and acetic acid (0.5%).

Pretreatment rapeseed protein isolate samples: About 1 g of sample was weighed in a 50 mL Greiner tube and diluted with 9 mL of an aqueous solution of methanol (50%) and acetic acid (0.5%). Samples were shaken for about 60 minutes at 2,000 rpm and maintained overnight at 4° C. after which samples were centrifuged (4,500 rpm, 10 min, 4° C.). 1 mL of the supernatant was transferred to a 2 mL Eppendorf tube and centrifuged again (14,000 rpm, 10 min, 4° C.). 0.5 mL of the supernatant was analyzed in the above HPLC procedure.

Solutions were injected into the liquid chromatograph and peak areas were measured with the aid of the integrator. The retention time to be expected for sinapic acid is ˜12 minutes.

A calibration curve was calculated using Chromeleon, Empower or Excel and the slope was used in the below calculations.

The sinapic acid concentration was calculated as follows:

Concentration (mg/kg)=[[Area_{Sinapic acid}−intercept]*Volume]/[Slope*Weight]*1000
Area_{Sinapic acid}=Area of sinapic acid peak
Intercept=Intercept of calibration curve of sinapic acid
Slope=Slope of calibration curve of sinapic acid
Volume=Volume solution (in L)
Weight=Sample amount (in gram)

The total phenolics concentration was calculated as follows:

Concentration (mg/kg)=[[Area_{Total}−intercept]*Volume]/[Slope*Weight]*1000
Area_{Total}=Sum if the total peak area detected at 320 nm
Intercept=Intercept of calibration curve of sinapic acid
Slope=Slope of calibration curve of sinapic acid
Volume=Volume solution (in L)
Weight=Sample amount (in gram)

Conductivity

The conductivity of native rapeseed protein isolate in a 2 wt. % aqueous solution was measured using a conductivity meter: Hach sensION+EC71.

Solubility Test

The below solubility test is adapted from Morr et al. (J. Food Sci. (1985) 50, 1715-1718), the difference being the use of water instead of 0.1 M sodium chloride.

Sufficient protein powder to supply 0.8 g of protein was weighed into a beaker. A small amount of demineralized water was added to the powder and the mixture was stirred until a smooth paste was formed. Additional demineralized water was then added to make a total weight of 40 g (yielding a 2 wt % protein dispersion). The dispersion was slowly stirred for at least 30 min using a magnetic stirrer. Afterwards the pH was determined and adjusted to the desired level (2, 3, 4, etc.) with sodium hydroxide or hydrochloric acid. The pH of the dispersion was measured and corrected periodically for 60 minutes stirring. After 60 minutes of stirring, an aliquot of the protein dispersion was reserved for protein content determination (Kjeldahl analysis). Another portion of the sample was centrifuged at 20,000 g for 2 min. The supernatant and pellet were separated after centrifugation. The protein content was also determined by Kjeldahl analysis.

Protein solubility (%)=(protein in supernatant/protein in total dispersion)×100.

Alternative methods for determining solubility are available and in some case use buffers, like borate-phosphate buffer in WO 2011/057408. However, such as values are incomparable with the ones obtained in the instant application that are determined in the absence of buffer.

MW Determination by Blue Native PAGE

In the case of Native PAGE, the protein charge has an impact on the electrophoretic mobility. In the case of Blue native PAGE (and to the contrary of clear native PAGE), the Coomassie Brilliant Blue dye provides the necessary charges to the protein complexes for the electrophoretic separation.

The proteins were dissolved in 500 mM sodium chloride. As high salt concentrations are incompatible with electrophoretic separation, the sample was diluted 10-fold with water (final salt concentration: 50 mM). Coomassie® G-250 (SimplyBlue™, ThermoFischer Scientific) was used and gels were scanned with an ExQuest™ Spot Cutter (BioRad). Resultant bands after carrying out Blue Native PAGE were observed. It would be expected that bands around 14 kDa indicate 2S, around 150 kDa indicate 7S and around 300 kDa indicate 12S proteins.

Cruciferin/Napin (C/N) Ratio

The C/N ratio was determined by Size Exclusion Chromatography (SEC) analysis. Samples were dissolved in a 500 mM sodium chloride saline solution and analyzed by HP-SEC using the same solution as the mobile phase. Detection was done by measuring UV absorbance at 280 nm. The relative contribution of cruciferin and napin (%) was calculated as the ratio of the peak area of each protein with respect to the sum of both peak areas.

Phytate Level

Phytates were measured at Eurofins using method QD495, based on Ellis et al. (Anal. Biochem. (1977) 77, 536-539).

### Comparative Example 1

### Preparation of Native Rapeseed Protein Isolate from Cold-Pressed Rapeseed Oil Seed Meal

The rapeseed protein isolate was produced from cold-pressed rapeseed oil seed meal having an oil content of less than 15% on dry matter basis, cleaned and processed below 75° C. The amount of phenolics in cold-pressed rapeseed oil seed meal was 17,000-17,600 mg/kg.

In the extraction step, the cold-pressed rapeseed oil seed meal was mixed with an aqueous salt solution (1 to 5% sodium chloride), at a temperature between 40 to 75° C. The meal to aqueous salt solution ratio was in the range of from 1:5 to 1:20. After about 30 minutes to 1 hour the protein rich solution (extract) was separated from the insoluble material. The pH of the extract was adjusted to neutral and the extract was further processed to clarify the material and remove non-protein substances. In the decreaming step, the residual fat was removed using centrifugation. Non-protein substances were removed by adjusting the pH of the material to neutral in the presence of a salt with which phytate precipitates (e.g. calcium chloride). The formed precipitate is removed via a solid/liquid separation step (e.g. a membrane filter press or centrifugation) in which the impurities are removed in a solid salt form (e.g. calcium phytate). The extract was then concentrated and washed in an ultrafiltration/diafiltration (UF/DF) step. Finally, the washed concentrate was dried in a spray drier with an inlet temperature in the range of from 150 to 200° C. and an outlet temperature in the range of from 50 to 100° C. resulting in the rapeseed protein isolate. Several batches were prepared and tested.

The conductivity of the resultant native rapeseed protein isolates in a 2% solution was less than 4,000 μS/cm over a pH range of 2.5 to 11.5.

Blue Native PAGE: Main bands were observed roughly around 300 kDa, between the 242 and 480 kDa MW markers. Some staining was visible as a smear as lower MW (150 kDa and below). No clear bands were observed at 150 kDa. Based on these results, the rapeseed product contains the 12S form of cruciferin. The resultant native rapeseed protein isolate comprised in the range of from 40 to 65% cruciferins and 35 to 60% napins.

The resultant native rapeseed protein isolate contained less than 0.26 wt. % phytate and had an amount of phenolics of 3,500-7,400 mg/kg.

The resultant native rapeseed protein isolates had a solubility of at least 88% when measured over a pH range from 3 to 10 at a temperature of 23±2° C. as shown for two batches in the below Table.

| pH | 3 | 4 | 5 | 6 | 7 | 8 | 9 | 10 |
|---|---|---|---|---|---|---|---|---|
| Sample 1 | 98 | 96 | 89 | 95 | 95 | 97 | 97 | 98 |
| Solubility (%) | | | | | | | | |
| Sample 2 | 102.5 | 97.5 | 94.3 | 93.9 | 97.0 | 93.0 | 94.0 | 99.8 |
| Solubility (%) | | | | | | | | |

### Example 1

### Preparation of Rapeseed Protein Isolate from Cold-Pressed Rapeseed Oil Seed Meal in the Presence of L-Ascorbic Acid and/or Sodium Metabisulfite

The procedure as described in Comparative Example 1 was repeated in seven different ways, with different extraction liquid concentrations of the following additives at pH 5.9:

I. None (control)
II. L-Ascorbic acid (0.5 g/kg)
III. Sodium metabisulfite (0.1 g/kg)
IV. L-Ascorbic acid (0.5 g/kg) plus sodium metabisulfite (0.1 g/kg)
V. L-Ascorbic acid (0.5 g/kg) plus sodium metabisulfite (0.05 g/kg)
VI. L-Ascorbic acid (0.25 g/kg) plus sodium metabisulfite (0.1 g/kg)
VII. L-Ascorbic acid (0.25 g/kg) plus sodium metabisulfite (0.05 g/kg)

Number of runs performed for each combination of L-ascorbic acid and sodium metabisulfite were as in the below Table:

| Sodium metabisulfite | L-Ascorbic acid (g/kg in extraction liquid) | | |
|---|---|---|---|
| (g/kg in extraction liquid) | 0 | 0.25 | 0.5 |
| 0 | 2 | — | 1 |
| 0.05 | — | 3 | 1 |
| 0.1 | 1 | 1 | 1 |

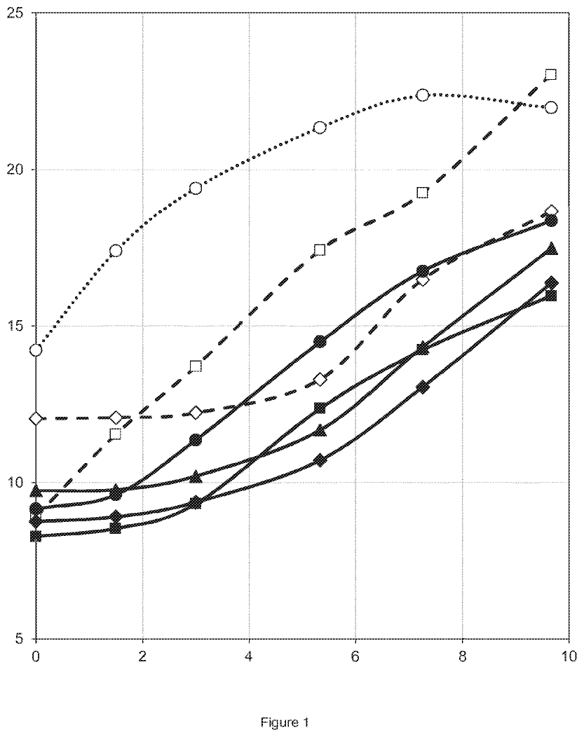

Following the precipitate removal via a solid/liquid separation step and prior to concentration and washing, incubation was performed in a shaking water bath (56° C.; 100 rpm; 0-3h) in 50 ml Greiner tubes (closed lid). Samples for HP-SEC and color analysis were taken from the incubation tube at t=0 h, t=1.5 h and t=3 h. At t=3 h the samples were stored frozen (−20° C.). After 10 weeks of storage, the experiment was continued by thawing and centrifuging (10,000 g; 5 min) the samples and continuing incubation as described above. Samples for color analysis were taken every ˜2 h. The results of color measurements using the method described above with a UV spectrophotometer are given in FIG. 1.

The yield on napins (in %) during incubation of clarified extract without (control) or with L-ascorbic acid and/or sodium metabisulfite at t=0 h, t=1.5 h and at t=3 h was determined. The napin concentration of the control at t=0 h was set at 100%, with [napin]_{t=0 h}=7.55 mg/g. See below Table:

| Additive | t = 0 h | t = 1.5 h | t = 3 h |
|---|---|---|---|
| None | 100 | 100 | 100 |
| L-Ascorbic acid, 0.5 g/kg | 102 | 102 | 102 |
| Sodium metabisulfite (0.1 g/kg) | 100 | 100 | 99 |
| L-ascorbic acid (0.25 g/kg) plus | 99 | 98 | 99 |
| sodium metabisulfite (0.05 g/kg) | | | |
| L-ascorbic acid (0.25 g/kg) plus | 100 | 97 | 98 |
| sodium metabisulfite (0.1 g/kg) | | | |
| L-ascorbic acid (0.5 g/kg) plus | 97 | 99 | 100 |
| sodium metabisulfite (0.05 g/kg) | | | |
| L-ascorbic acid (0.5 g/kg) plus | 101 | 99 | 98 |
| sodium metabisulfite (0.1 g/kg) | | | |

Standard deviations for color analysis, cruciferins, napins and cruciferin/napin ratio, obtained for the center point (L-ascorbic acid (0.25 g/kg) plus sodium metabisulfite (0.05 g/kg)) were as follows:

| | Standard Deviation (%) | | | |
|---|---|---|---|---|
| Time (h) | Color | Cruciferin | Napin | Cruciferin/Napin |
| 0 | 1.6 | 0.7 | 2.0 | 2.1 |
| 1.5 | 1.1 | 2.1 | 2.9 | 0.8 |
| 3 | 0.6 | 2.1 | 1.7 | 0.9 |
| 5.3 | 1.1 | Not measured | Not measured | Not measured |
| 7.3 | 0.5 | Not measured | Not measured | Not measured |
| 9.7 | 0.5 | Not measured | Not measured | Not measured |

With respect to color, it was observed that sodium metabisulfite results in an initial removal of color (i.e. lower 100-L value) which is not persistent over time, in fact 100-L surpasses that of the untreated control after 9 hours of incubation. For L-ascorbic acid, a smaller initial removal of color is observed, however this effect is more stable over time and eventually results in a 100-L value that is significantly below that of the control. When L-ascorbic acid and sodium metabisulfite are combined, an additional effect is observed. This applies for all tested combinations during the first three hours, i.e. L-ascorbic acid (0.25 g/kg) plus sodium metabisulfite (0.05 g/kg), L-ascorbic acid (0.25 g/kg) plus sodium metabisulfite (0.1 g/kg), L-ascorbic acid (0.5 g/kg) plus sodium metabisulfite (0.05 g/kg), and L-ascorbic acid (0.5 g/kg) plus sodium metabisulfite (0.1 g/kg), for 3 hours. For the combinations, wherein L-ascorbic acid is at least 0.5 g/kg and/or sodium metabisulfite is at least 0.1 g/kg, an effect was observed also during the subsequent 7 hours. Generally, the relative color difference between control and extracts treated with both L-ascorbic acid and sodium metabisulfite was maximal (approximately 50%) between 3-5 h of incubation. For the napins, no significant decrease in yield was observed for the control nor for any of the tested concentrations of L-ascorbic and/or sodium metabisulfite, all remained well above 95% of the initial napin concentration of the control within the first three hours of incubation.

### Example 2

### Preparation of Rapeseed Protein Isolate from Cold-Pressed Rapeseed Oil Seed Meal in the Presence of L-Ascorbic Acid and Sodium Metabisulfite

In a series of preparations, the procedure as described in Comparative Example 1 was repeated on pilot plant scale whereby L-ascorbic acid and sodium metabisulfite were added during the extraction step (percentages in the below Table relative to weight of the mixture of rapeseed oil seed meal and aqueous salt solution). Color of the dried product of two batches was determined using the method described above with a Hunterlab spectrophotometer. Solutions of 1% were prepared in a 0.2 M phosphate buffer at pH 6. Before measurement the samples were filtered on a 0.45 μm filter to remove particles if present. Measured values were as follows:

| | L-ascorbic | sodium metabi- | | | | |
|---|---|---|---|---|---|---|
| # | acid (%) | sulfite (%) | L | a | B | YI E313 |
| 1 | 0 | 0 | 87.33 | −2.64 | 22.13 | 44.72 |
| 2 | 0 | 0 | 87.98 | −3.36 | 24.15 | 48.03 |
| 3 | 0.044 | 0.006 | 91.08 | −4.74 | 22.41 | 41.79 |
| 4 | 0.044 | 0.006 | 89.45 | −4.34 | 22.72 | 43.51 |
| 5 | 0.044 | 0.006 | 88.69 | −4.65 | 23.81 | 45.90 |
| 6 | 0.044 | 0.006 | 89.13 | −4.69 | 24.54 | 47.16 |
| 7 | 0.044 | 0.006 | 89.66 | −4.93 | 24.09 | 45.78 |
| 8 | 0.088 | 0.0082 | 92.87 | −5.86 | 24.25 | 43.79 |
| 9 | 0.088 | 0.0082 | 93.43 | −8.7 | 32.13 | 56.95 |
| 10 | 0.088 | 0.0082 | 92.38 | −8.58 | 33.57 | 60.57 |
| 11 | 0.088 | 0.0082 | 93.32 | −5.78 | 23.8 | 42.75 |

Samples that were treated with L-ascorbic acid and sodium metabisulfite had an amount of phenolics of 2,000-3,000 mg/kg.

### Example 3

### Preparation of a Sweet Native Rapeseed Protein Isolate

A 2% sodium chloride solution was made in 8 L of potable water at 55° C. This solution was well-mixed with an overhead stirrer and temperature was maintained using a double jacket vessel attached to a water bath. A dried native rapeseed protein isolate from Example 2 (152 g of a sample wherein 0.088% of L-ascorbic acid and 0.0082% of sodium metabisulfite was used) was slowly added and mixed for 1 h to establish complete solubilization. Evaporation was minimized by using a lid. The obtained solution was concentrated/diafiltrated over two membranes using a lab-scale cross flow system of JM Separation F-PV030 C/D.

To obtain native rapeseed protein isolate fraction I (>50 kDa), the solution was concentrated 3.6-4 times (applied conditions: 55° C./cross flow 340 to 360 L/h/TMP <1.5 bar) over a 50 kDa PES CDUF006TQ membrane of Millipore and diafiltrated with 10 volumes of potable water (similar conditions as for concentrating). The retentate was concentrated as far as possible (until the void volume of the system) and subsequently diafiltrated with 3 volumes of potable water (similar conditions as for concentrating). The retentate was drained and the system was washed with 400-450 mL water to obtain more product. The retentate and the wash were combined (native rapeseed protein isolate fraction I) and frozen overnight (−20° C.) in freeze-drying bottles. The permeate and the various diafiltrates were collected and stored overnight at 4 to 6° C.

To obtain native rapeseed protein isolate fraction II (5 to 50 kDa), the combined permeate and diafiltrates were concentrated 21 times (applied conditions: 55° C./cross flow 340 to 360 Uh/TMP <3.5 bar) over a 5 kDa regenerated cellulose membrane (Millipore CDUF006LC membrane). The obtained retentate was subsequently diafiltrated with 10 volumes of potable water (applied conditions: 55° C./cross flow 340 to 360 L/h/TMP <3.5 bar). The retentate was concentrated as far as possible (until the void volume of the system) and subsequently diafiltrated with 3 volumes of potable water (similar conditions as for concentration). The retentate was drained and the system was washed with 400 to 450 mL water to obtain more product. The retentate and the wash were combined (native rapeseed protein isolate fraction II) and frozen overnight (−20° C.) in freeze-drying bottles.

Freeze-drying was done with a SalmenKipp Christ Freeze Dryer D-DV007 (Beta 2-8 LD plus). The ice condenser setpoint was −90° C. and the vacuum setpoint was 0.0055 mbar. The frozen samples were connected to the freeze drier and in approximately 1.5 week the samples were dried. The napin and cruciferin composition were determined as outlined in the below Table. As can be seen, fraction II contained highly purified napin.

| | Start sample from Example 1 | | | |
|---|---|---|---|---|
| | Native rapeseed protein | | Native rapeseed protein | |
| | isolate sample 1 | | isolate sample 2 | |
| Fraction | I | II | I | II |
| Napin (mg/g) | 75 | 825 | 34 | 836 |
| Cruciferin (mg/g) | 831 | 5 | 925 | 0 |
| Total nitrogen | 150 | 178 | 151 | 179 |
| (mg/g) | | | | |
| Napin/Cruciferin | 0.091 | 165 | 0.037 | >836 |
| ratio | | | | |
| Phenolics (mg/kg) | 500 | 1,800 | 300 | 1,700 |
| % (wt.) napin | 7.5% | 82.5% | 3.4% | 83.6% |

### Example 4

### Comparison of Sweetness

The sweetness characteristics of food ingredients can be evaluated by comparing aqueous solutions. Here, aqueous solutions of 2% from the materials obtained in Comparative Example 1 and Example 3 were prepared at room temperature. Eight persons evaluated the protein solutions, comparing the three solutions and ranking them according to sweetness as outlined in the below Table.

| | | Sensory description |
|---|---|---|
| Code | 2% aqueous solution | of sweetness |
| A | Native rapeseed protein | Slightly sweet; less |
| | isolate sample 1 (of | sweet than C |
| | Comparative Example 1) | |
| B | Fraction I (Example 3) | Not sweet |
| C | Fraction II (Example 3) | Sweet; significantly |
| | | sweeter than A |

### Example 5

### Determination of Sweetness

The flavor characteristics of food ingredients can be evaluated by sensory specialists using techniques known in the art. Here, a panel (n=5) of persons trained to determine sweetness, assessed the native rapeseed protein isolate of the present invention, taking in account Good Sensory Practices.

A 2% native rapeseed protein isolate solution of fraction II of Example 3 was prepared and provided to the panelists at room temperature. Five sucrose solutions were prepared (1.5%, 2%, 3%, 4% and 5%) and coded such that the panelists could not be influenced. These reference products were given one-by-one and in different random order to the individual panel members. The products were administered in white polystyrene cups. The panelists were instructed first to drink from the reference cup and afterwards from the native rapeseed protein isolate solution fraction II and determine if the latter was less, equal, or sweeter than the reference. In between, the panelist neutralized their oral cavity with plain crackers, carbonated and plain water.

As can be extracted from the data in the below Table, the native rapeseed protein isolate of the present invention has a sweetness equivalence factor of 1.5 to 2; i.e. a 2 wt. % aqueous solution provides similar sweetness as 30 to 40 g/L sucrose.

TABLE
Number of panelists scoring sweetness of a 2% aqueous solution
of native rapeseed protein isolate of the present invention
versus reference sucrose solutions (n = 5)

| | Fraction II is | Fraction II has similar | Fraction II is |
|---|---|---|---|
| | less sweet | sweetness | sweeter |
| Sucrose 1.5% | 0 | 0 | 5 |
| Sucrose 2% | 0 | 0 | 5 |
| Sucrose 3% | 1 | 2 | 2 |
| Sucrose 4% | 4 | 0 | 1 |
| Sucrose 5% | 5 | 0 | 0 |

### Example 6

### Fortifying Sweetened Almond Milk to a Protein Level Comparable to Dairy Milk

As a reference, unsweetened almond milk with added 3 wt. % whey protein isolate and 3 wt. % sugar was prepared (3% sugar is the regular sugar level in commercial sweetened almond milk). Regular almond milk contains 0.5% protein, and by adding an extra 3% protein the total protein level is 3.5%, which is comparable to regular dairy milk.

A series of products were prepared, starting from unsweetened almond milk with added 3 wt. % of fraction II of Example 3 (leading to a total of 3.5% protein, similar as in the reference product) and x % sugar (x=1 wt. %, 1.5 wt. %, 2 wt. % and 2.5 wt. %). It was found that the sweetness of unsweetened almond milk with added 3 wt. % of fraction II of Example 3 and 1.5 to 2% sugar provided a similar sweetness as the reference.

In this Example, 33 to 50% of the total added sugar can be reduced when fortifying almond milk with the native rapeseed protein isolate of the present invention to a protein level comparable to dairy milk.

### Example 7

### Sweetening of Almond Milk with Native Rapeseed Protein Isolate

As a test product, unsweetened almond milk with added 3 wt. % of fraction II of Example 3 was prepared. The sweetness of this food product was compared to a series of products, starting from unsweetened almond milk with added x % sugar (x=2%, 2.5%, 3%, 3.5% and 4%).

It was found that the sweetness of the test product, unsweetened almond milk with added 3% of the native rapeseed protein isolate of the present invention provided similar sweetness as unsweetened almond milk with added 3.5 to 4% sucrose.

In this Example, the native rapeseed protein isolate of the present invention has a sweetness equivalent factor of 1.2 to 1.3; i.e. 30 g/L of the native rapeseed protein isolate of the present invention provides similar sweetness as 30 to 40 g/L sucrose in a food product. While at the same time the added native rapeseed protein isolate fortifies the almond milk to a protein level of dairy milk.

1. A native rapeseed protein isolate comprising more than 60 wt. % napins and from 30 to 3,000 mg/kg of phenolics.

2. The native rapeseed protein isolate according to claim 1 which has, in a 2 wt. % solution in water, a sweetness equivalent to an aqueous sucrose solution of at least 10 g/L.

3. The native rapeseed protein isolate according to claim 1 comprising 80±10 wt. % napins.

4. The native rapeseed protein isolate according to claim 1 which has, in a 2 wt. % solution in water, a sweetness equivalent to an aqueous sucrose solution of at least 25 g/L.

5. The native rapeseed protein isolate according to claim 1 wherein said napins are proteins with a molecular weight of from 10 to 15 kDa as determined by Blue Native PAGE.

6. The native rapeseed protein isolate according to claim 1 having a protein content of at least 90 wt. % (Nx6.25) on a dry weight basis.

7. The native rapeseed protein isolate according to claim 1 having a phytate level less than 0.4 wt. %.

8. A process for obtaining a native rapeseed protein isolate comprising:
i) mixing cold-pressed rapeseed oil meal with an aqueous liquid at a temperature of from 45 to 65° C.;
ii) separation of the aqueous liquid from the mixture obtained in i);
iii) decreaming of the aqueous liquid obtained in ii);
iv) adjusting the pH of the decreamed aqueous liquid obtained in iii) to neutral by adding acid or base, and mixing with a precipitant to obtain a precipitate wherein said precipitant comprises a salt of magnesium, zinc, iron, or calcium;
v) removing the precipitate obtained in iv) to obtain an aqueous liquid;
vi) concentrating and washing the aqueous liquid obtained in v);
vii) subjecting the concentrated and washed aqueous liquid obtained in vi) to filtration over a membrane with a cut off >50 kDa;
viii) subjecting the permeate obtained in vii) to filtration over a membrane with a cut off between 5 and 50 kDa;
ix) isolating native rapeseed protein isolate from the concentrated and washed aqueous retentate obtained in vi) by means of drying,
wherein ascorbic acid or a derivative thereof and a sulfite is added before, during or after any of i) or ii) or iii) or iv) or v) or vi).

9. The process according to claim 8 wherein in i) the aqueous liquid is an aqueous salt solution comprising 1 to 5 wt. % sodium chloride.

10. A product comprising native rapeseed protein isolate to capable of being used to increase the sweetness of a food product.

11. The product according to claim 10 to increase the protein level of said food product.

12. Use of A product comprising native rapeseed protein isolate capable of being used to reduce the amount of sugar and/or sucrose in a food product.

13. The product according to claim 10 wherein said native rapeseed protein isolate is napin.

14. A food product comprising the rapeseed protein isolate according to claim 1.

15. A food product according to claim 14 which is a beverage, confectionary product, health bar, chocolate, or a milk powder.
